(19) United States
(12) Patent Application Publication
(10) Pub. No.: US 2021/0406773 A1
(43) Pub. Date: Dec. 30, 2021

(54) TRANSFORMING METHOD, TRAINING DEVICE, AND INFERENCE DEVICE

(71) Applicant: Preferred Networks, Inc., Tokyo (JP)

(72) Inventors: Yoshihiro NAGANO, Tokyo (JP); Shoichiro YAMAGUCHI, Tokyo (JP)

(21) Appl. No.: 17/444,301

(22) Filed: Aug. 3, 2021

Related U.S. Application Data
(63) Continuation of application No. PCT/JP2020/003260, filed on Jan. 29, 2020.
(60) Provisional application No. 62/802,317, filed on Feb. 7, 2019.

(51) Int. Cl. G06N 20/00; G06N 5/02; G06F 16/31

(52) U.S. Cl. CPC G06N 20/00; G06F 16/322; G06N 5/02

(57) ABSTRACT

With respect to a transforming method for execution by at least one computer, the transforming method includes transforming a first probability distribution on a space defined with respect to a hyperbolic space to a second probability distribution on the hyperbolic space.

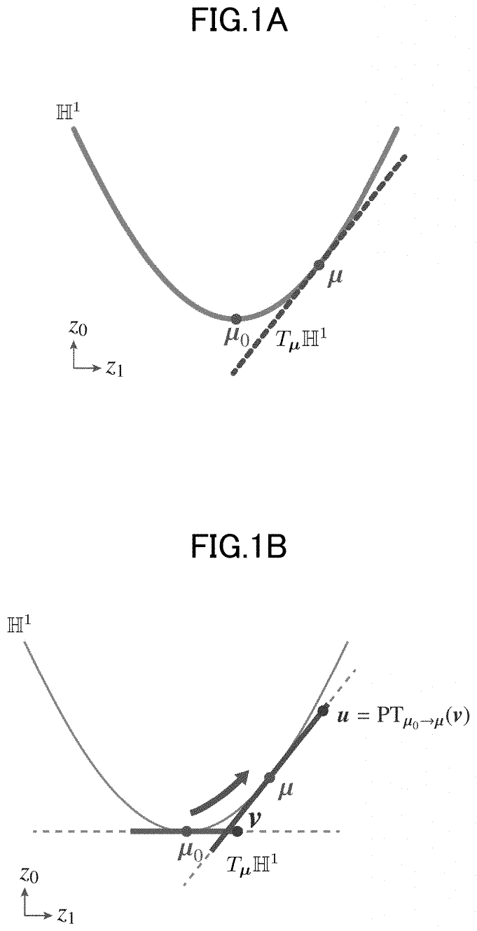

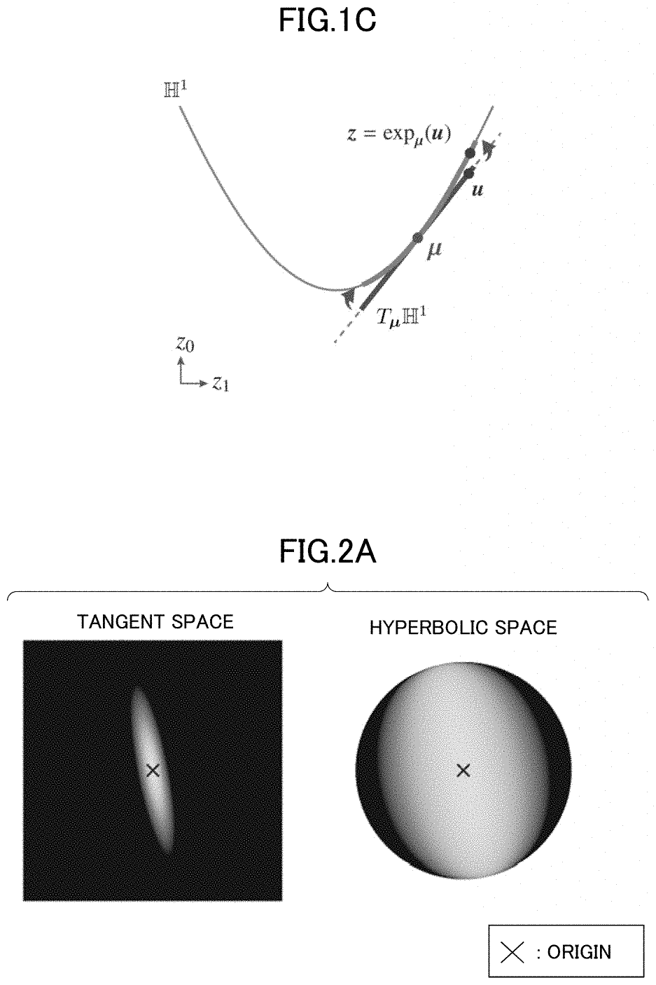

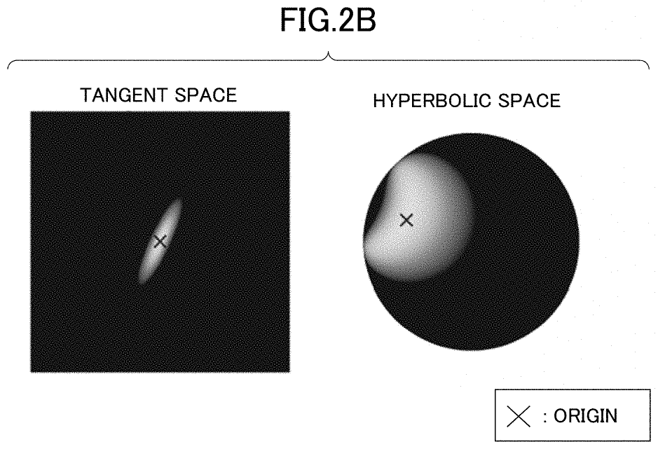

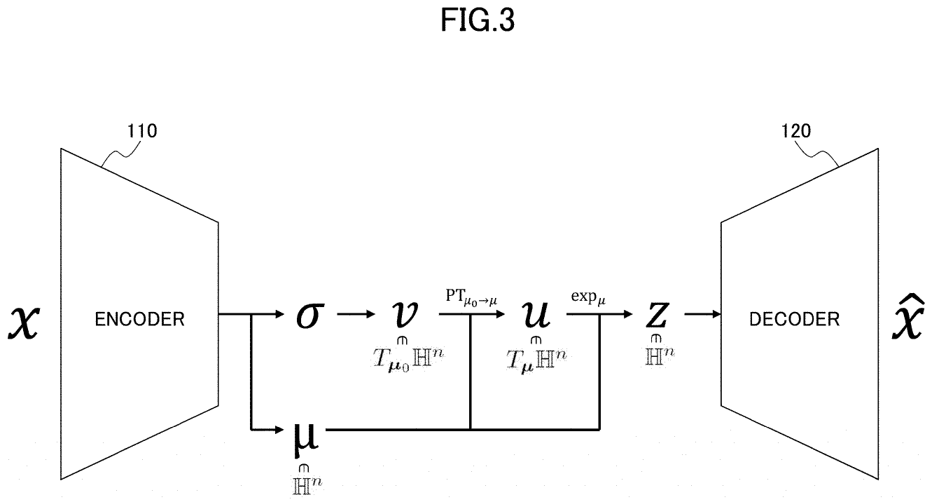

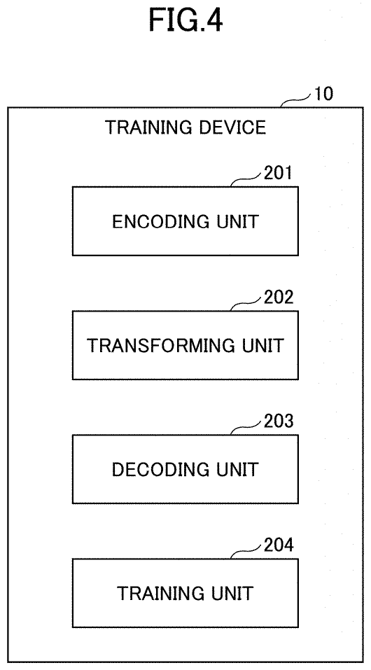

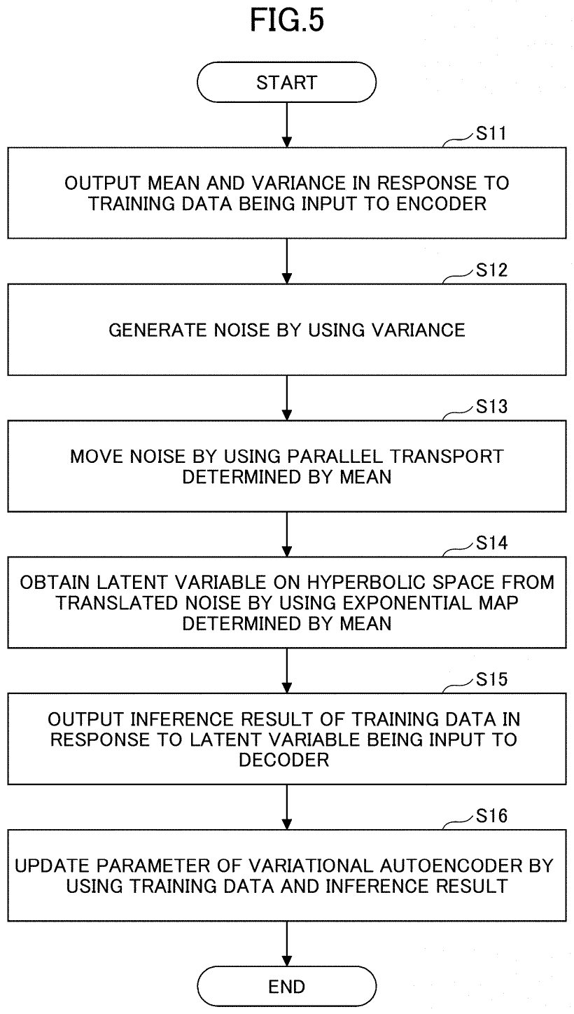

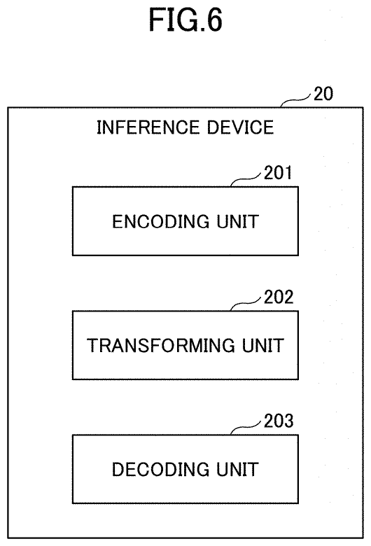

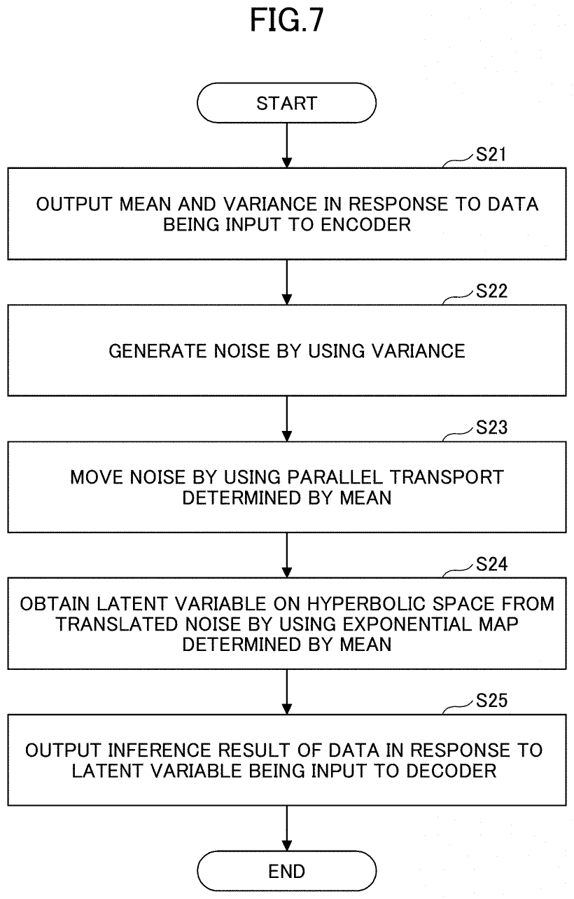

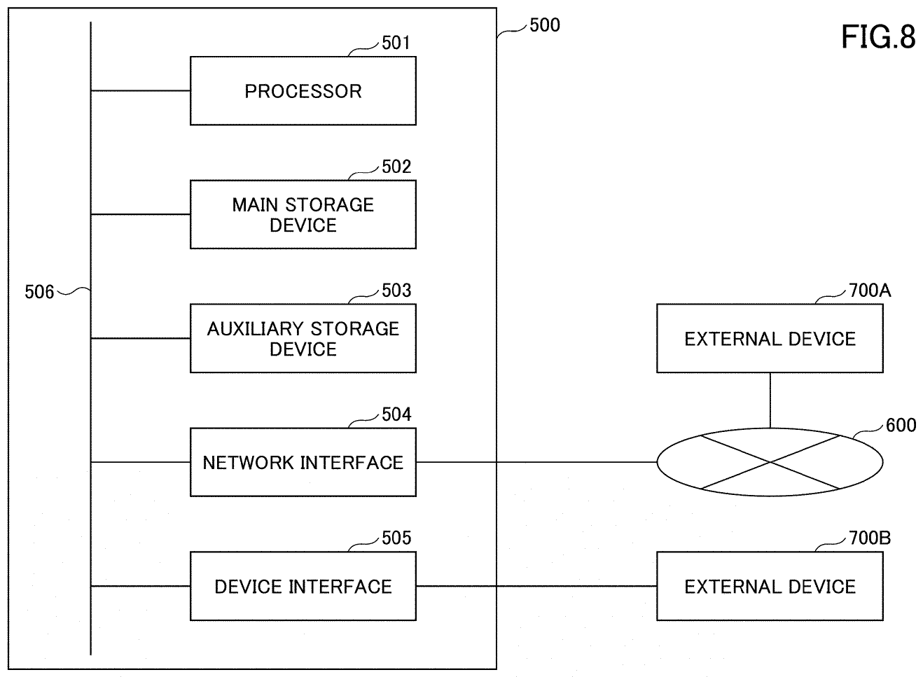

### BACKGROUND

The present disclosure relates to a method of obtaining a probability distribution on a hyperbolic space, a training device, an inference device, and a system.

### SUMMARY

One embodiment of the present disclosure includes a method of parameterizing a probability distribution that includes a transforming step of defining a probability distribution on a tangent space that is tangent to a hyperbolic space and transforming the probability distribution on the tangent space to a probability distribution on the hyperbolic space.

### DETAILED DESCRIPTION

The present disclosure proposes a novel method of obtaining a probability distributions on a hyperbolic space.

In one embodiment of the present disclosure, a space of a latent variable of a variable autoencoder can be extended from an Euclidean space to a hyperbolic space.

In this case, a probability distribution, in which 1) the density can be calculated explicitly, 2) the sampling is differentiable, and 3) the non-Euclidean distance of the hyperbolic space is reflected, is introduced.

According to the method of parameterizing the probability distribution, the training device, the inference device, and the system of the present disclosure, the following effects can be expected.

For example, a probability density function of a probability distribution is precisely determined, thereby making the sampling easier.

For example, because the value of the probability density function can be calculated, thereby calculating the probability that a particular sample value will appear.

For example, the occurrence of error due to the presence of the terms difficult to be calculated and the necessity of using approximate values can be reduced. This can appropriately perform the training in the training device and the inference in the inference device.

For example, even though the latent space is a stochastic generation model as in word embedding, the representation of each entry in the latent space can be treated as a distribution rather than a point, so that the uncertainty and the inclusion relation of each entry can be modeled, and a richer structure can be embedded in the latent space

A configuration of the system according to one embodiment of the present disclosure will be described.

The figure below is a functional block diagram of an example of the training device according to one embodiment.

As illustrated in the figure above, the training device includes, for example, an encoder, a transforming unit, a decoder, and an error calculating unit.

The figure below is a functional block diagram of the inference device according to one embodiment.

As illustrated in the figure above, the inference device includes at least an encoder, a transforming unit, and a decoder.

An example of the training device or the inference device according to the present disclosure will be described.

The figure below is a diagram illustrating an architecture of a neural network of the device according to one embodiment of the present disclosure, and particularly corresponds to the structure described in “4.1. Hyperbolic Variational Autoencoder” of “A Differentiable Gaussian-like Distribution on Hyperbolic Space for Gradient-Based Learning”, which is part of the present provisional application.

The figure below is a high level block diagram illustrating a training process of the training device according to one embodiment of the present disclosure.

One embodiment of the training device 500 according to the present disclosure is a variation encoder that includes a variational encoder 202 being an encoder including a first neural network including an input layer, at least one hidden layer including multiple nodes, and an output layer; a transforming unit (402) that receives an output from the variational encoder 202 (output data of the encoder) as an input; and a variational decoder 400 being a decoder including an input layer that receives an output from the transforming unit 402 (output data of the transforming unit) as an input, at least one hidden layer including multiple nodes, and an output.

In an exemplary embodiment, a configuration of the variational autoencoder is used as the training device 500 to train the variational encoder 202 and the variational decoder 400. For example, the neural networks included in the variational encoder 202 and the variational decoder 400 are simultaneously trained as an autoencoder using backpropagation with stochastic gradient descent to maximize a variational lower bound. For example, the backpropagation may repeatedly include forward propagation and backward propagation in hidden layers, and updating of weights, by using, for example, logarithmic likelihood. The variational encoder 202 for data type X may be trained using all of a set {x1, x2, . . . xn} and the data type X. As a result, once trained, the variational encoder 202 properly encodes the input variable x.

An example of the variational autoencoder of the present embodiment includes a variational encoder 202 that includes a first neural network including an input layer, at least one hidden layer including multiple nodes, and an output layer; a transforming unit (402 or the like) that receives an output from the encoder as an input; and a variation decoder 400 including an input layer that receives an output from the transforming unit as an input, at least one hidden layer including multiple nodes, and an output layer.

An example of the transforming unit according to the present disclosure is described in other part of the present disclosure. A specific method of transforming a probability variable include an exponential map and parallel transport.

As described, by using the probability variable obtained by being transformed into the hyperbolic space, various things, such as generation of new data substantially the same as the training data, interpolation of existing data points, interpretation of relationships between data, are enabled.

The figure below is a flowchart illustrating training steps of the training device of one embodiment of the present disclosure.

First, the training data is input into the training device. As training data, for example, a type of data set having a tree structure may be useful. Specifically, the training data is input into an encoder for encoding to obtain an output of the mean and variance.

Next, for example, in the transforming unit, noise is generated using the variation.

Next, for example, the noise is moved using parallel transport determined by the mean and variance.

Next, for example, the moved noise is transformed (embedded) into the hyperbolic space by using an exponential map determined by the mean and variance.

Then, for example, the transformed data is input into a decoder that decodes the transformed data, and output data is received.

Then, for example, training is performed by using the data input into the encoder and the output data obtained from the decoder. For example, the loss between the data input into the encoder and the data output from the decoder is calculated and the training is performed by using the error backpropagation method. These steps are repeated until the desired accuracy is achieved.

The variational autoencoder that is trained as described can explicitly calculate the density of the probability distribution. Thus, unlike the case where the conventional hyperbolic space is used for the latent variable space, it is not necessary to use the error or an approximate value for sampling, and thus a time duration (a time duration until the training is completed) and cost required until the variation autoencoder having a predetermined accuracy is achieved can be reduced. Additionally, a model of the autoencoder with a high accuracy can be obtained.

The figure below is a flow chart illustrating inference steps of the inference device of one embodiment of the present disclosure.

The inference steps of the inference device of one embodiment of the present disclosure are described below.

First, input data is input into an encoder for encoding, and an output of the mean and variance is received.

Next, for example, noise is generated using the variance.

Next, for example, the noise is moved using parallel transport determined by the mean and variance.

Next, for example, the moved noise is embedded (transformed) in the hyperbolic space by using an exponential map determined by the mean and variance.

Next, for example, the transformed data is input into a decoder for decoding and an output is received.

As data that can be used in the present disclosure, any data may be used as long as a type of the data is a data type in which a latent structure can be extracted. For example, various data types may be used, such as handwritten sketches, music, chemicals, and the like. For example, it can be suitably used for a type of data having a tree structure. The type of data having a tree structure includes a natural language, more specifically, a natural language in which Zipf's law is found, and a network having scale-free characteristics, such as a social network and a semantic network. Because the hyperbolic space is a curved space with a constant negative curvature, one embodiment of the present disclosure can efficiently represent a structure such that its volume increases exponentially, such as a tree structure.

In one embodiment according to the present disclosure, although a hyperbolic space of the Lorentz model is used as the hyperbolic space, other types of models of the hyperbolic space may be used. Alternatively, different kinds of models of the hyperbolic spaces can be used by transforming the models to each other.

In the exemplary embodiment, as a latent distribution z, any suitable type of probability distribution that can maximize the variational lower bound can be used. As the latent distribution z, for example, multiple various types of probability distributions in relation to various basic characteristics in the input data can be used. Generally, the characteristics can be represented by a Gaussian distribution best, but in the exemplary embodiment, time-based characteristics may be represented by a Poisson distribution and/or space-based characteristics may be represented by a Rayleigh distribution.

The figure below is a block diagram illustrating an example of a hardware configuration in one embodiment of the present disclosure.

The device, the system, and the like according to the embodiment described above include a processor 71, a main storage device 72, an auxiliary storage device 73, a network interface 74, and a device interface 75, and may be implemented as a computer device 7 in which these components are connected through a bus 76.

Here, the computer device 7 illustrated in the figure includes one component each, but may include multiple identical components. Additionally, although one computer device 7 is illustrated, the software may be installed in multiple computer devices and each of the multiple computer devices may perform different parts of the processing of the software.

The processor 71 is an electronic circuit (a processing circuit, or processing circuitry) including a computer control device and an arithmetic device. The processor 71 performs arithmetic processing based on data and programs input from each device or the like in the internal configuration of the computer device 7 and outputs an arithmetic result or a control signal to each device or the like. Specifically, the processor 71 controls the respective components constituting the computer device 7 by executing an OS (operating system) of the computer device 7, an application, and the like. As the processor 71, any device can be used as long as the above-described processes can be performed. The device, the systems, etc. and respective components thereof are implemented by the processor 71. Here, the processing circuit may refer to one or more electronic circuits disposed on one chip, or may refer to one or more electronic circuits disposed on two or more chips or devices.

The main storage device 72 is a storage device that stores instructions executed by the processor 71, various data, and the like, and the information stored in the main storage device 72 is directly read by the processor 71. The auxiliary storage device 73 is a storage device other than the main storage device 72. Here, these storage devices indicate any electronic component that can store electronic information, and may be either a memory or a storage. Additionally, there are a volatile memory and a non-volatile memory as the memory, and the memory may be either a volatile memory or a non-volatile memory. The memory in which the device, the system, or the like stores various data, for example, a storage unit 30 may be implemented by the main storage device 72 or the auxiliary storage device 73. For example, at least part of the respective storage unit described above may be implemented by the main storage device 72 or the auxiliary storage device 73. As another example, if an accelerator is provided, at least part of the respective storage units described above may be implemented by a memory provided in the accelerator.

The network interface 74 is an interface that connects to the communication network 8, either wirelessly or by wire. The network interface 74 that is compliant with an existing communication standard may be used. The network interface 74 may exchange information with an external device 9A communicated through the communication network 8.

The external device 9A may include, for example, a camera, a motion capturing device, a destination device, an external sensor, an input source device, and the like. The external device 9A may also be a device that functions as a part of the components of the inference device 500 or the training device. Then, the computer device 7 may receive a portion of the processing result of the inference device or the training device 500 through the communication network 8, as in a cloud service. Additionally, a server may be connected to the communication network 8 as the external device 9A and the trained model may be stored in the server serving as the external device 9A. In this case, the inference device or the training device 500 may access the server serving as the external device 9A through the communication network 8 and may perform determination of being diseased.

The device interface 75 is an interface, such as a universal serial bus (USB), that directly connects to an external device 9B. The external device 9B may be an external recording medium or a storage device. Each storage device may be implemented by the external device 9B.

The external device 9B may be an output device. The output device may be, for example, a display device that displays an image, or a device that outputs an audio or the like. Examples may include, a liquid crystal display (LCD), a cathode ray tube (CRT), a plasma display panel (PDP), a speaker, and the like, but the examples are not limited to these.

Here, the external device 9B may be an input device. The input device may include, for example, a device, such as a keyboard, a mouse, or a touch panel. Information input by the device is provided to the computer device 7. Signals from the input device are output to the processor 71.

A person skilled in the art may come up with addition, effects or various kinds of modifications of the present disclosure based on the above-described entire description, but examples of the present disclosure are not limited to the above-described individual embodiments. Various kinds of addition, changes and partial deletion can be made within a range that does not depart from the conceptual idea and the gist of the present disclosure derived from the contents stipulated in claims and equivalents thereof.

1. A method of parameterizing a probability distribution, the method comprising a transforming step of defining a probability distribution on a tangent space that is tangent to a hyperbolic space, and transforming the probability distribution on the tangent space to a probability distribution on the hyperbolic space.

2. The method as claimed in claim 1, wherein the transforming step includes transforming the probability distribution on the tangent space to the probability distribution on the hyperbolic space by using an exponential map.

3. The method as claimed in claim 1 or 2, wherein the transforming step includes performing parallel transport on the tangent space in the hyperbolic space.

4. The method as claimed in any one of claims 1 to 3, wherein a type of data relating to the probability distribution has a tree structure.

5. A training device comprising:
a transforming unit that defines a tangent space that is tangent to a hyperbolic space, defines a probability distribution on the tangent space, and transforms the probability distribution on the tangent space to a probability distribution on the hyperbolic space, with respect to an output from an encoder including a first neural network model; and
a decoder including a second neural network model, an output of the decoder being performed based on data transformed by the transforming unit.

6. The training device as claimed in claim 5, wherein the transforming unit transforms the probability distribution on the tangent space to the probability distribution on the hyperbolic space by using an exponential map.

7. The training device as claimed in claim 5 or 6, wherein the transforming unit performs parallel transport on the probability distribution on the tangent space.

8. The training device as claimed in any one of claims 5 to 7, wherein data is sampled from the probability distribution.

9. An inference device comprising:
an encoder and a decoder each including a machine learning model; and
a transforming unit that defines a tangent space that is tangent to a hyperbolic space, defines a probability distribution on the tangent space, and transforms the probability distribution on the tangent space to a probability distribution on the hyperbolic space, with respect to an output from the encoder.

10. The inference device as claimed in claim 9, wherein the transforming unit transforms the probability distribution on the tangent space to the probability distribution on the hyperbolic space by using an exponential map.

11. The inference device as claimed in claim 9 or 10, wherein the transforming unit performs parallel transport on the probability distribution on the tangent space.

12. The inference device as claimed in any one of claims 9 to 11, wherein data is sampled from the probability distribution.

13. A system comprising:
an encoder and a decoder each including a machine learning model; and
a transforming unit that defines a tangent space with respect to a hyperbolic space, defines a probability distribution on the tangent space, and transforms the probability distribution on the tangent space to a probability distribution on the hyperbolic space, with respect to an output from the encoder,
wherein an output of the decoder is performed based on data transformed by the transforming unit.
